(19) United States
(12) Patent Application Publication
(10) Pub. No.: US 2023/0342415 A1
(43) Pub. Date: Oct. 26, 2023

(54) FEATURE EXTRACTION METHOD AND APPARATUS FOR THREE-DIMENSIONAL FEATURE MAP, STORAGE MEDIUM, AND ELECTRONIC DEVICE

(71) Applicant: Beijing Horizon Robotics Technology Research and Development Co., Ltd., Beijing (CN)

(72) Inventors: Yinan ZHANG, Beijing (CN); Delin LI, Beijing (CN); Jianjun LI, Beijing (CN)

(73) Assignee: Beijing Horizon Robotics Technology Research and Development Co., Ltd., Beijing (CN)

(21) Appl. No.: 18/192,548

(22) Filed: Mar. 29, 2023

(30) Foreign Application Priority Data
Apr. 22, 2022 (CN) 202210429575.X

(51) Int. Cl. G06F 17/15

(52) U.S. Cl. CPC G06F 17/153

(57) ABSTRACT

Disclosed are a feature extraction method and apparatus for a three-dimensional feature map, a storage medium, and an electronic device. The method includes: determining an overlay parameter based on depth information of a three-dimensional feature map to be processed; decomposing the three-dimensional feature map into a plurality of target two-dimensional feature maps based on the depth information and the overlay parameter; performing two-dimensional convolution processing on each of the plurality of target two-dimensional feature maps to obtain a plurality of initial feature maps; and determining a target feature map corresponding to the three-dimensional feature map based on the plurality of initial feature maps.

### CROSS-REFERENCE TO RELATED APPLICATIONS

This application claims priority to Chinese Patent Application No. 202210429575.X, entitled “FEATURE EXTRACTION METHOD AND APPARATUS FOR THREE-DIMENSIONAL FEATURE MAP, STORAGE MEDIUM, AND ELECTRONIC DEVICE”, filed with the China National Intellectual Property Administration (CNIPA) on Apr. 22, 2022, the entire disclosure of which is incorporated by reference in its entirety herein.

### FIELD OF THE INVENTION

The present disclosure relates to a feature extraction method and apparatus for a three-dimensional feature map, a storage medium, and an electronic device.

### BACKGROUND OF THE INVENTION

With increasing demand for 3D models in fields such as automatic driving, it becomes imperative that three-dimensional convolution processing is supported. However, most of existing hardware components support only two-dimensional convolution processing; and development of hardware lags behind evolution of algorithms. Therefore, a hardware component in a conventional technology usually cannot support three-dimensional convolution processing.

### SUMMARY OF THE INVENTION

To resolve the foregoing technical problem, the present disclosure is proposed. Embodiments of the present disclosure provide a feature extraction method and apparatus for a three-dimensional feature map, a storage medium, and an electronic device.

According to an aspect of the present disclosure, a feature extraction method for a three-dimensional feature map is provided, including:

Determining an overlay parameter based on depth information of a three-dimensional feature map to be processed;

Decomposing the three-dimensional feature map into a plurality of target two-dimensional feature maps based on the depth information and the overlay parameter;

Performing two-dimensional convolution processing on each of the plurality of target two-dimensional feature maps to obtain a plurality of initial feature maps; and

Determining a target feature map corresponding to the three-dimensional feature map based on the plurality of initial feature maps.

According to another aspect of the present disclosure, a feature extraction apparatus for a three-dimensional feature map is provided, including:

A parameter determination module, configured to determine an overlay parameter based on depth information of a three-dimensional feature map to be processed;

A feature map decomposition module, configured to decompose the three-dimensional feature map into a plurality of target two-dimensional feature maps based on the depth information and the overlay parameter determined by the parameter determination module;

A convolution processing module, configured to perform two-dimensional convolution processing on each of the plurality of target two-dimensional feature maps obtained from the feature map decomposition module to obtain a plurality of initial feature maps; and

A feature determination module, configured to determine a target feature map corresponding to the three-dimensional feature map based on the plurality of initial feature maps obtained from the convolution processing module.

According to still another aspect of the present disclosure, a computer readable storage medium is provided, in which a computer program is stored, and the computer program is used for implementing the feature extraction method for a three-dimensional feature map described in any one of the foregoing embodiments.

According to yet another aspect of the present disclosure, an electronic device is provided, where the electronic device includes:

A processor; and

A memory, configured to store a processor-executable instruction, where

The processor is configured to read the executable instruction from the memory, and execute the instruction to implement the feature extraction method for a three-dimensional feature map described in any one of the foregoing embodiments.

Based on the feature extraction method and apparatus for a three-dimensional feature map, the storage medium, and the electronic device that are provided in the foregoing embodiments of the present disclosure, the three-dimensional feature map to be processed is decomposed into a plurality of target two-dimensional feature maps based on the depth information and the overlay parameter, so that a hardware device supporting two-dimensional convolution processing may process the target two-dimensional feature map; and the target feature map corresponding to the three-dimensional feature map to be processed is determined based on the initial feature map obtained by processing the target two-dimensional feature map. In other words, three-dimensional convolution processing on the three-dimensional feature map is implemented by the two-dimensional convolution processing. Because implementation of a processing process depends on only the two-dimensional convolution processing, the three-dimensional convolution processing on the three-dimensional feature map may be implemented while a hardware supporting the two-dimensional convolution processing is implemented, without changing a configuration of the hardware.

### BRIEF DESCRIPTION OF THE DRAWINGS

By describing the embodiments of the present disclosure in more detail with reference to the accompanying drawings, the foregoing and other objectives, features, and advantages of the present disclosure will become more apparent. The accompanying drawings are provided for further understanding of the embodiments of the present disclosure, constituting a part of the specification, and are used to explain the present disclosure together with the embodiments of the present disclosure, without limitation to the present disclosure. In the accompanying drawings, same reference numerals generally represent same components or steps.

FIG. 1 is a schematic diagram of mapping from Conv3d to Conv2d according to an exemplary embodiment of the present disclosure;

FIG. 2 is a schematic flowchart of a feature extraction method for a three-dimensional feature map according to an exemplary embodiment of the present disclosure;

FIG. 3 is a schematic flowchart of step 202 in the embodiment shown in FIG. 2 of the present disclosure;

FIG. 4a is a schematic flowchart of step 204 in the embodiment shown in FIG. 2 of the present disclosure;

FIG. 4b is a schematic flowchart of step 2042 in the embodiment shown in FIG. 4a of the present disclosure;

FIG. 5 is a schematic flowchart of step 206 in the embodiment shown in FIG. 2 of the present disclosure;

FIG. 6 is a schematic flowchart of step 208 in the embodiment shown in FIG. 2 of the present disclosure;

FIG. 7 is a schematic structural diagram of a feature extraction apparatus for a three-dimensional feature map according to an exemplary embodiment of the present disclosure;

FIG. 8 is a schematic structural diagram of a feature extraction apparatus for a three-dimensional feature map according to another exemplary embodiment of the present disclosure; and

FIG. 9 is a structural diagram of an electronic device according to an exemplary embodiment of the present disclosure.

### DETAILED DESCRIPTION OF THE EMBODIMENTS

Exemplary embodiments of the present disclosure are described below in detail with reference to the accompanying drawings. Obviously, the described embodiments are merely a part, rather than all, of embodiments of the present disclosure. It should be understood that the present disclosure is not limited by the exemplary embodiments described herein.

It should be noted that the scope of the present disclosure is not limited by relative arrangement, numeric expressions, and numerical values of components and steps described in these embodiments, unless otherwise specified.

A person skilled in the art may understand that terms such as “first” and “second” in the embodiments of the present disclosure are merely used for distinguishing among different steps, devices, modules or the like, and indicate neither any particular technical meaning, nor necessarily logical ordering among them.

It should be further understood that, in the embodiments of the present disclosure, the term “multiple”/“a plurality of” may refer to two or more; and the term “at least one” may refer to one, two, or more.

It should be further understood that, any component, data, or structure involved in the embodiments of the present disclosure may be generally construed to one or more, unless clearly stated or the context indicates otherwise.

In addition, the term “and/or” in the present disclosure refers to only an association relationship that describes associated objects, indicating presence of three relationships. For example, A and/or B may indicate presence of three cases: A alone, both A and B, and B alone. In addition, the character “/” in the present disclosure generally indicates an “or” relationship of associated objects.

The embodiments of the present disclosure may be applicable to a terminal device, a computer system, a server, and other electronic devices, which may be operated together with numerous other general-purpose or special-purpose computing system environments or configurations. These electronic devices may be described in general context of a computer system-executable instruction (such as a program module) executed by the computer system. Generally, the program module may include a routine, a program, a target program, a component, logic, a data structure, and the like that execute particular tasks or implement particular abstract data types. The computer system/server may be implemented in a distributed cloud computing environment. In the distributed cloud computing environment, a task is performed by a remote processing device linked through a communications network. In the distributed cloud computing environment, the program module may be located on a storage medium of a local or remote computing system including a storage device.

### Application Overview

In a process of implementing the present disclosure, the inventor finds that a hardware device provided in a conventional technology may support only two-dimensional convolution processing, and cannot support three-dimensional convolution processing.

A pseudocode for convolution processing of a 3D convolution (conv3d) network is offered as follows:

```
// conv3d
for (co)
  for (h, h += kh)
    for (w, w += kw)
      for (d, d += kd)
        for (kh)
          for (kw)
            for (kd)
              for (ci)
```

It may be learned from the pseudocode that, a calculation process of 3D convolution includes 8 layers of loops: Loop at an outermost layer includes calculating and outputting Cout iteration; loop at inner 2-4^{th} layers includes performing an addition operation on dimensions of h (height, representing a height of a feature map), w (width, representing a width of the feature map), and d (a depth, representing a depth of the feature map, that is, an added dimension of a 3D feature map relative to a 2D feature map); loop at further inner 5-7^{th} layers includes sliding of a kernel (a convolution kernel for an convolution operation, where sliding is performed on the feature map by using the convolution kernel as an unit to perform a multiply-add operation) required for an output point on an input, where kernel sizes in the three directions of h, w, and d need to be accumulated, represented as kh, kw, and kd; and loop at an innermost layer includes accumulation in a direction of an input channel (channel, as a dimension common to 2D convolution and 3D convolution, where no sliding but only accumulation is performed on this dimension).

In general, the loops at the four outer layers include traversing of a 4-dimensional output point (without considering a batch), and the loops at the four inner layers include traversing multiply-accumulate data required for one output point.

3D convolution (conv3d) differs from 2D convolution (conv2d) in that: not only sliding in the directions of h and w included in conv2d is performed, but also sliding in the direction of d is performed; and the kernel is four-dimensional, where sliding is performed in all of the directions of h, w, and d.

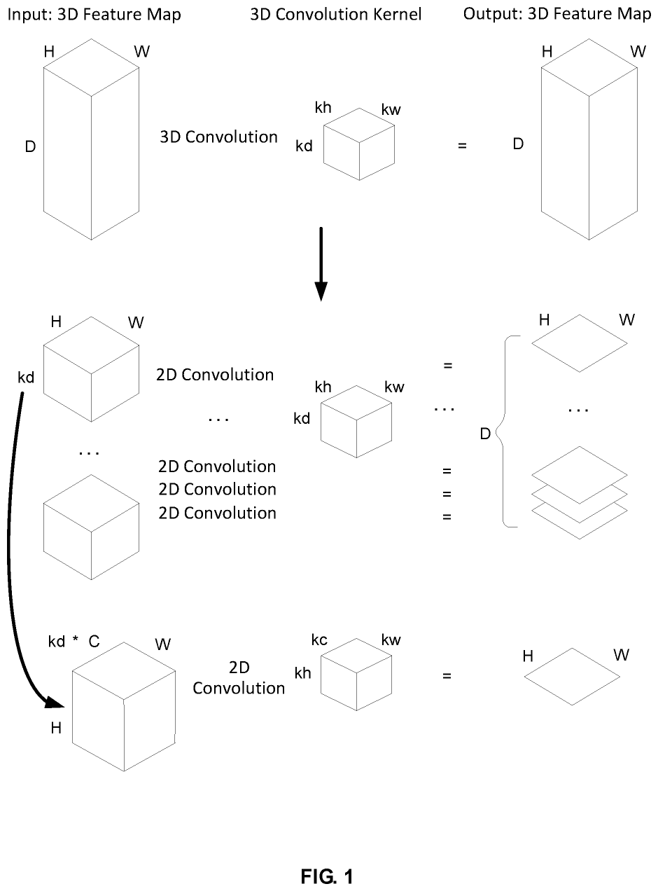

FIG. 1 is a schematic diagram of mapping from Conv3d to Conv2d according to an exemplary embodiment of the present disclosure. As shown in FIG. 1, according to this embodiment of the present disclosure, the loop in the d dimension in the 3D convolution is arranged at the outermost layer, 3D convolution processing of a 3D feature map (feature) is split into being for (d/kd) number of separate conv2d, where the 3D feature map is split in a D direction. A convolution kernel for each calculation in the 2D convolution is still a size of a 3D convolution kernel (kh*kw*kd), but a C size of a convolution kernel in the 2D convolution is kd*C (in other words, in this embodiment of the present disclosure, accumulation of kd is implemented by overlaying in a C direction, so as to arrange the loop in the d dimension at the outermost layer). In addition, a result of each calculation of 2D convolution is a feature map (H*W) of a point output in the D direction. A 3D feature map corresponding to the 3D convolution may be obtained by overlaying the feature map output by each 2D convolution in the D direction.

A calculation process of splitting conv3d into conv2d may be implemented through the following pseudocode:

```
for (d, d += kd)
  // conv2d
for (co)
    for (h, h += kh)
      for (w, w += kw)
        for (kh)
          for (kw)
            for (ci*kd)
```

Compared with conv2d, there is additionally d-dimensional data in conv3d. Therefore, converting conv3d into conv2d is to extract calculation for the d-dimensional data, including accumulation of d-dimensional data at an output point and a kernel d (kd) at input. Herein, traversal of the d-dimensional data is arranged at the outermost layer for calculation, and accumulation on the kernel d is overlaid in a direction of the input channel. In this pseudocode, except for the d dimension at the outermost layer, the loop at the innermost layer is a conv2d. The conv2d includes input of a feature shape of h*w*(ci*kd), and a weight shape of kh*kw*(ci*kd) for a convolution kernel, and thereby a 3d convolution operation may be performed by cycling conv2d for d/kd times.

### Exemplary Method

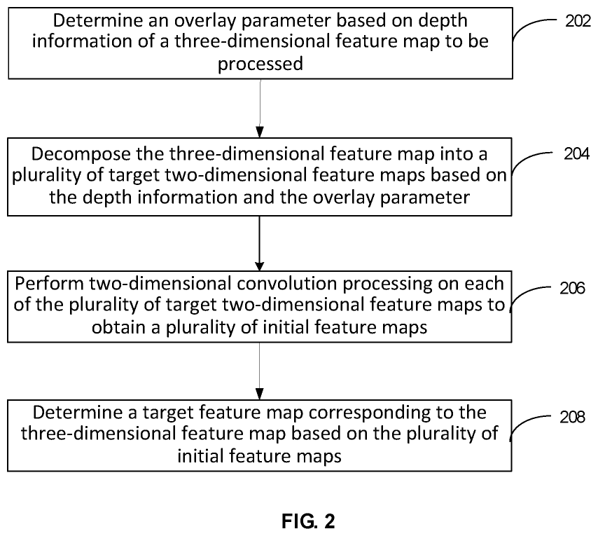

FIG. 2 is a schematic flowchart of a feature extraction method for a three-dimensional feature map according to an exemplary embodiment of the present disclosure. This embodiment may be applied to an electronic device. As shown in FIG. 2, the method includes the following steps.

Step 202. Determine an overlay parameter based on depth information of a three-dimensional feature map to be processed.

A three-dimensional feature map includes depth information that is not included in a two-dimensional feature map. For example, the depth information of the three-dimensional feature map may be represented by d. The overlay parameter may indicate a size, in a depth direction, of a convolution kernel for 3d convolution, for example, kd provided in the embodiment described above.

Step 204. Decompose the three-dimensional feature map into a plurality of target two-dimensional feature maps based on the depth information and the overlay parameter.

In this embodiment, the three-dimensional feature map is decomposed in the depth direction to obtain the plurality of target two-dimensional feature maps. In this case, a convolution operation may be performed on each of the target two-dimensional feature maps through 2d convolution.

Step 206. Perform two-dimensional convolution processing on each of the plurality of target two-dimensional feature maps to obtain a plurality of initial feature maps.

Each of the target two-dimensional features map corresponds to one of the initial feature maps.

Each of the target two-dimensional feature maps obtained by decomposing the three-dimensional feature map is a two-dimensional feature map. In this case, a calculation may be performed on the two-dimensional feature map directly through conv2d, to obtain the initial feature map corresponding to each of the target two-dimensional feature maps.

Step 208. Determine a target feature map corresponding to the three-dimensional feature map based on the plurality of initial feature maps.

In this embodiment, because each of the plurality of initial feature maps does not include the depth information of the three-dimensional feature map in the depth direction, in order to obtain the target feature map corresponding to the three-dimensional feature map, operations such as overlaying may be performed on the plurality of initial feature maps to obtain the target feature map.

According to the feature extraction method for a three-dimensional feature map provided in the foregoing embodiment of the present disclosure, the three-dimensional feature map to be processed is decomposed into a plurality of target two-dimensional feature maps based on the depth information and the overlay parameter, so that a hardware device supporting two-dimensional convolution processing may process the target two-dimensional feature map; and the target feature map corresponding to the three-dimensional feature map to be processed is determined based on the initial feature map obtained by processing the target two-dimensional feature map. In other words, three-dimensional convolution processing on the three-dimensional feature map is implemented by the two-dimensional convolution processing. Because implementation of a processing process depends on only the two-dimensional convolution processing, the three-dimensional convolution processing on the three-dimensional feature map may be implemented while a hardware supporting the two-dimensional convolution processing is implemented, without changing a configuration of the hardware.

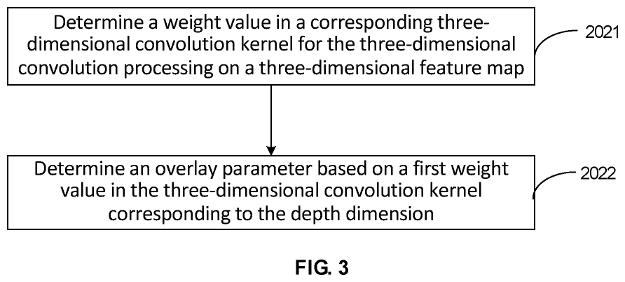

As shown in FIG. 3, on the basis of the embodiment shown in FIG. 2, step 202 may include the following steps.

Step 2021. Determine a weight value in a corresponding three-dimensional convolution kernel when a three-dimensional convolution processing is performed on the three-dimensional feature map.

When the three-dimensional feature map is processed by using a prior three-dimensional convolution network, the convolution kernel is a three-dimensional convolution kernel, wherein the three-dimensional evolution kernel includes information about a depth dimension that is not included in the two-dimensional evolution processing. In this embodiment, in order to decompose the three-dimensional feature map into two-dimensional feature maps that may be processed by a two-dimensional convolution network, reference may be made to the three-dimensional convolution kernel to determine how to decompose the three-dimensional feature map.

Step 2022. Determine the overlay parameter based on a first weight value in the three-dimensional convolution kernel corresponding to the depth dimension.

Optionally, the first weight value is taken as the overlay parameter.

In this embodiment, different dimensions in the three-dimensional convolution kernel correspond to different dimensions in the three-dimensional feature map. That is, the depth dimension in the three-dimensional convolution kernel corresponds to the depth information in the three-dimensional feature map. Therefore, in order to decompose the depth information in the three-dimensional feature map, the first weight value corresponding to the depth dimension in the three-dimensional convolution kernel may be taken as the overlay parameter. The three-dimensional feature map may be decomposed in the depth dimension based on the overlay parameter and the depth information in the three-dimensional feature map, so that the decomposed feature map may be processed through two-dimensional convolution, thereby improving decomposition efficiency of the three-dimensional feature map.

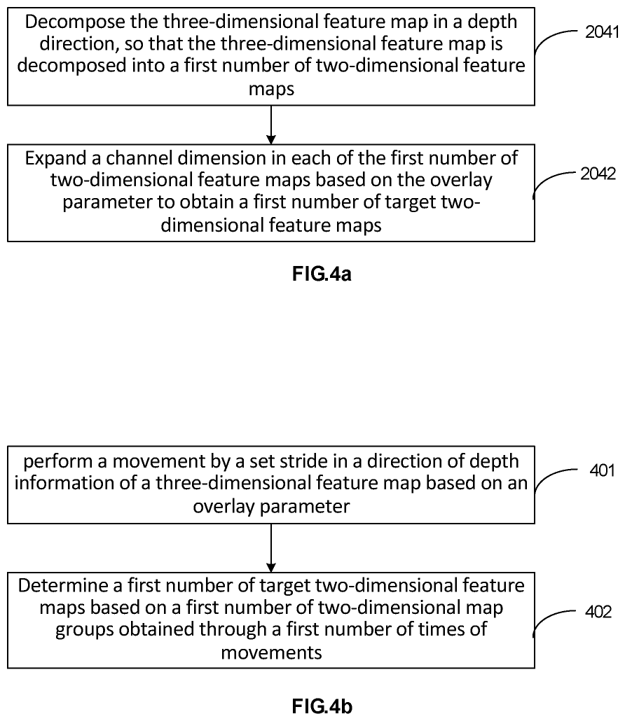

As shown in FIG. 4a, on the basis of the embodiment shown in FIG. 2, step 204 may include the following steps.

Step 2041. Decompose the three-dimensional feature map in a depth direction, so that the three-dimensional feature map is decomposed into a first number of two-dimensional feature maps.

The first number is an integer greater than 1.

Optionally, the first number may be determined based on the depth information of the three-dimensional feature map and the overlay parameter, for example, may be an integer obtained by dividing the depth information by the overlay parameter.

Step 2042. Expand a channel dimension in each of the first number of two-dimensional feature maps based on the overlay parameter to obtain the first number of target two-dimensional feature maps.

In this embodiment, the three-dimensional feature map is split in the depth direction, for example, the three-dimensional feature map is split into d/kd number of separate two-dimensional feature maps; whereas it is a convolution operation that is performed in the depth direction for the three-dimensional convolution processing, and thus compensation needs to be performed by an accumulation of the overlay parameter in other directions other than the depth direction. In this embodiment, the accumulation of the overlay parameter is performed by the overlaying in the channel dimension (for example, the c direction), or an accumulation of the kernel is separately performed one time so as to compensate for a calculation difference caused by splitting the depth information, so that information about the convolution processing of the depth information in a part of the three-dimensional feature maps may be included in each of the obtained target two-dimensional feature maps, so as to reach an aim that the target feature map corresponding to the three-dimensional feature map is obtained by overlaying the first number of target two dimensional feature maps.

As shown in FIG. 4b, on the basis of the embodiment shown in FIG. 4a as above, step 2042 may include the following steps.

Step 401. Performing a movement by a set stride in a direction of the depth information of the three-dimensional feature map based on the overlay parameter.

Optionally, the set stride is a distance for which the overlay parameter moves in a direction of the depth information, and a value of the set stride may be set according to an actual scenario. For example, the three-dimensional feature map has dimensions of 1×111×111×111 (a dimension of the depth information) ×64 as an example, wherein the three-dimensional convolution kernel has a dimension of 3×3×3, padding has a dimension of 1×1×1, a stride of the three-dimensional convolution has a dimension of 1×1×1, and 111 conv2d may be obtained after split. In this example, the value of the set stride is 1.

Step 402. Determine the first number of target two-dimensional feature maps based on a first number of two-dimensional map groups obtained through a first number of times of movements.

In this embodiment, each of the two-dimensional map groups may be taken as a target two-dimensional feature map. By performing the movement in the direction of the depth information based on the set stride, one two-dimensional map group may be obtained through each movement. A specific process of obtaining the target two-dimensional feature map may include:
obtaining, based on each of the first number of times of movements, a two-dimensional feature map group including a second number of two-dimensional feature maps, the second number indicating a number of the overlay parameters; and
determining each of the two-dimensional feature map groups as a feature map on one channel in the target two-dimensional feature map, to obtain the first number of target two-dimensional feature maps with the second number of channels.

In this embodiment, the two-dimensional feature map group after depth information is split is obtained by each movement. In order to reduce an amount of information lost in a splitting process of the depth information, an overlay operation is performed in a channel direction by using the overlay parameter in this embodiment. For example, if the number of channels in the three-dimensional feature map is 64 (for example, the dimension of the three-dimensional feature map is 1×111×111×111×64), the overlay parameter is 3, and the number of channels in the target two-dimensional feature map obtained after split is 3×64, a dimension of the two-dimensional feature map required for calculation at a first point in the depth dimension is 1×111×111×(2×64). In this embodiment, expression of the depth information in the three-dimensional feature map by the target two-dimensional feature map is improved by performing an overlay in the channel dimension, thereby improving accuracy of the target feature map obtained based on the target two-dimensional feature map.

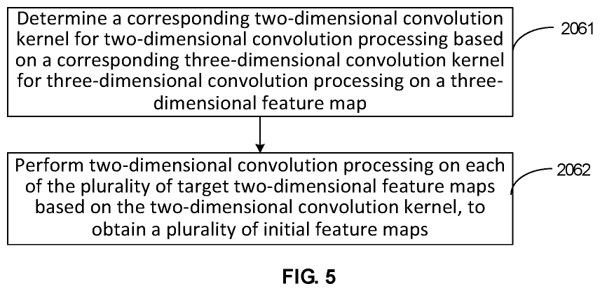

As shown in FIG. 5, on the basis of the embodiment shown in FIG. 2, step 206 may include the following steps.

Step 2061. Determine a corresponding two-dimensional convolution kernel for the two-dimensional convolution processing based on a corresponding three-dimensional convolution kernel for the three-dimensional convolution processing on the three-dimensional feature map.

Optionally, the two-dimensional convolution kernel obtained based on the three-dimensional convolution kernel may be obtained directly by eliminating the depth dimension or by complementing in another dimension on the basis of eliminating the depth dimension.

Step 2062. Perform two-dimensional convolution processing on each of the plurality of target two-dimensional feature maps based on the two-dimensional convolution kernel, to obtain a plurality of initial feature maps.

In this embodiment, a process of a convolution calculation is performed by using the two-dimensional convolution kernel. Because both an object of the convolution calculation (the target two-dimensional feature map) and the convolution kernel are two-dimensional, the calculation process is the same as a common two-dimensional convolution calculation process. A plurality of initial feature maps may be obtained by respectively performing the two-dimensional convolution processing on each of the target two-dimensional feature maps. The target feature map is determined based on the plurality of initial feature maps. In other words, it may be achieved that three-dimensional convolution processing is performed on the three-dimensional feature map through a two-dimensional convolution operation. In this case, feature extraction of the three-dimensional feature map may be achieved merely by using hardware capable of supporting the two-dimensional convolution calculation, without processing the hardware.

Optionally, step 2061 may include the following steps.
a1. Merge a first value of the corresponding depth dimension in the three-dimensional convolution kernel and a second value of a corresponding channel dimension in the three-dimensional convolution kernel, to obtain a third value.

The third value may be equal to a product obtained by multiplying the first value by the second value.
a2. Determine the third value as a value of a corresponding channel dimension in the two-dimensional convolution kernel to obtain the two-dimensional convolution kernel with a reduced number of dimensions.

In this embodiment, in the process of decomposing the three-dimensional feature map into a plurality of target two-dimensional feature maps, because overlaying is performed in the channel dimension of the target two-dimensional feature map, overlaying is also performed in the channel dimension in the corresponding convolution kernel, that is, the product of the first value and the second value is used as the value of the channel dimension in the two-dimensional convolution kernel, so that the dimensions of the two-dimensional convolution kernel correspond to those of the target two-dimensional feature map, thereby further facilitating the convolution calculation of the target two-dimensional feature map.

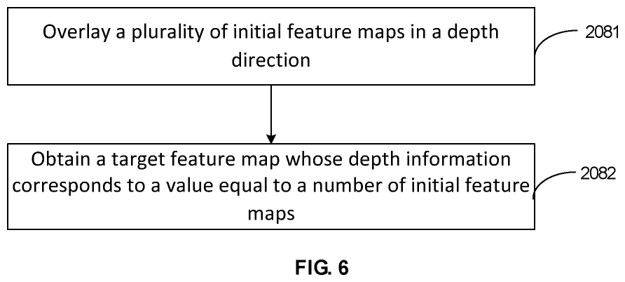

As shown in FIG. 6, on the basis of the embodiment shown in FIG. 2, step 208 may include the following steps.

Step 2081. Overlay the plurality of initial feature maps in the depth direction.

Step 2082. Obtain the target feature map whose depth information corresponds to a value equal to the number of the initial feature maps.

In this embodiment, the plurality of initial feature maps are overlaid in the depth direction of the feature map. By overlaying in the depth direction, it is achieved that the output target feature map may reflect the depth information. In other words, a result of the three-dimensional feature map through the three-dimensional convolution processing is restored, thereby achieving a technical effect of obtaining the result of the three-dimensional convolution processing based on the two-dimensional convolution calculation.

Any feature extraction method provided in the embodiments of the present disclosure may be implemented by any suitable device with a data processing capability, including but not limited to a terminal device and a server. Alternatively, any feature extraction method for a three-dimensional feature map provided in the embodiments of the present disclosure may be implemented by a processor. For example, the processor implements any feature extraction method for a three-dimensional feature map described in the embodiments of the present disclosure by invoking a corresponding instruction stored in a memory. Details are not described below again.

### Exemplary Device

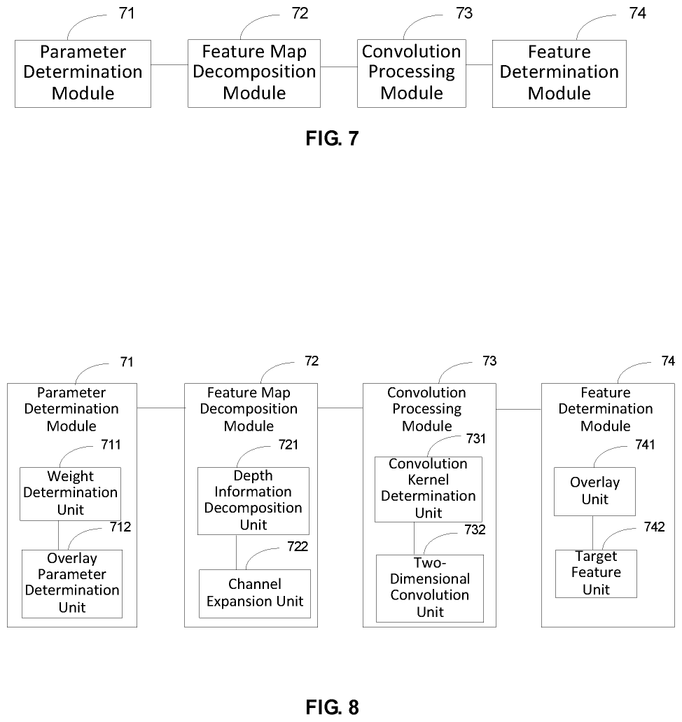

FIG. 7 is a schematic structural diagram of a feature extraction apparatus for a three-dimensional feature map according to an exemplary embodiment of the present disclosure. As shown in FIG. 7, the apparatus provided in this embodiment includes:
a parameter determination module 71, configured to determine an overlay parameter based on depth information of a three-dimensional feature map to be processed;
a feature map decomposition module 72, configured to decompose the three-dimensional feature map into a plurality of target two-dimensional feature maps based on the depth information and the overlay parameter determined by the parameter determination module 71;
a convolution processing module 73, configured to perform two-dimensional convolution processing on each of the plurality of target two-dimensional feature maps obtained from the feature map decomposition module 72, to obtain a plurality of initial feature maps; and
a feature determination module 74, configured to determine a target feature map corresponding to the three-dimensional feature map based on the plurality of initial feature maps obtained from the convolution processing module 73.

According to the feature extraction apparatus for a three-dimensional feature map provided in the foregoing embodiment of the present disclosure, the three-dimensional feature map to be processed is decomposed into a plurality of target two-dimensional feature maps based on the depth information and the overlay parameter, so that a hardware device supporting two-dimensional convolution processing may process the target two-dimensional feature map; and the target feature map corresponding to the three-dimensional feature map to be processed is determined based on the initial feature map obtained by processing the target two-dimensional feature map. In other words, three-dimensional convolution processing on the three-dimensional feature map is implemented by the two-dimensional convolution processing. Because implementation of a processing process depends on only the two-dimensional convolution processing, the three-dimensional convolution processing on the three-dimensional feature map may be implemented while a hardware supporting the two-dimensional convolution processing is implemented, without changing a configuration of the hardware.

FIG. 8 is a schematic structural diagram of a feature extraction apparatus according to another exemplary embodiment of the present disclosure. As shown in FIG. 8, in the apparatus provided in this embodiment, the parameter determination module 71 includes:
a weight determination unit 711, configured to determine a weight value in a corresponding three-dimensional convolution kernel for the three-dimensional convolution processing on the three-dimensional feature map; and
an overlay parameter determination unit 712, configured to determine the overlay parameter based on a first weight value in the three-dimensional convolution kernel corresponding to the depth dimension.

In some optional embodiments, the feature map decomposition module 72 includes:
a depth information decomposition unit 721, configured to decompose the three-dimensional feature map in a depth direction, so that the three-dimensional feature map is decomposed into a first number of two-dimensional feature maps, where
the first number is an integer greater than 1; and
a channel expansion unit 722, configured to expand a channel dimension in each of the first number of two-dimensional feature maps based on the overlay parameter to obtain the first number of target two-dimensional feature maps.

Optionally, the depth information decomposition unit 721 is specifically configured to perform a movement by a set stride in a direction of the depth information of the three-dimensional feature map based on the overlay parameter; and determine the first number of target two-dimensional feature maps based on the first number of two-dimensional map groups obtained through the first number of times of movements.

Optionally, the depth information decomposition unit 721 is further configured to obtain, based on each of the first number of times of movements, a two-dimensional feature map groups including a second number of two-dimensional feature maps, the second number indicating a number of the overlay parameters; and determine each of the two-dimensional feature map groups as a feature map on one channel in the target two-dimensional feature map, to obtain the first number of target two-dimensional feature maps with the second number of channels.

In some optional embodiments, the convolution processing module 73 includes:
a convolution kernel determination unit 731, configured to determine a corresponding two-dimensional convolution kernel for the two-dimensional convolution processing based on a corresponding three-dimensional convolution kernel for the three-dimensional convolution processing on the three-dimensional feature map; and
a two-dimensional convolution unit 732, configured to perform two-dimensional convolution processing on each of the plurality of target two-dimensional feature maps based on the two-dimensional convolution kernel, to obtain a plurality of initial feature maps.

Optionally, the convolution kernel determination unit 731 is specifically configured to merge a first value of the corresponding depth dimension in the three-dimensional convolution kernel and a second value of a corresponding channel dimension in the three-dimensional convolution kernel, to obtain a third value; and determine the third value as a value of a corresponding channel dimension in the two-dimensional convolution kernel to obtain the two-dimensional convolution kernel with a reduced number of dimensions.

In some optional embodiments, the feature determination module 74 includes:
an overlay unit 741, configured to overlay the plurality of initial feature maps in the depth direction; and
a target feature unit 742, configured to obtain the target feature map whose depth information corresponds to a value equal to the number of the initial feature maps.

### Exemplary Electronic Device

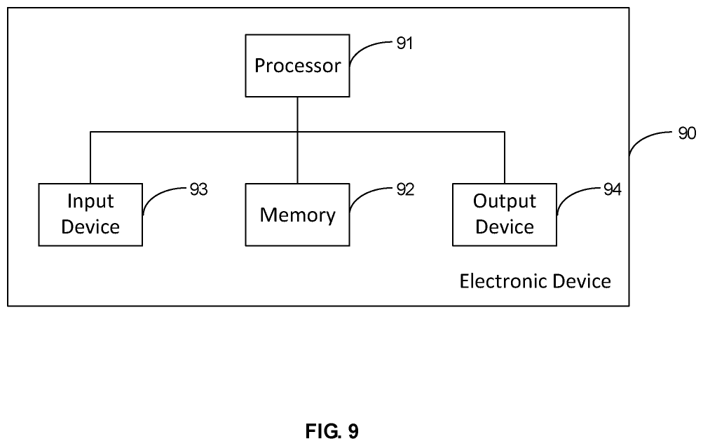

An electronic device according to an embodiment of the present disclosure is described below with reference to FIG. 9. The electronic device may be any one or two of a first device 100 and a second device 200, or a stand-alone device separated from the first device and the second device. The stand-alone device may communicate with the first device and the second device, to receive an obtained input signal therefrom.

FIG. 9 shows a block diagram of an electronic device according to an embodiment of the present disclosure.

As shown in FIG. 9, an electronic device 90 includes one or more processors 91 and a memory 92.

The processor 91 may be a central processing unit (CPU) or another form of processing unit having a data processing capability and/or an instruction execution capability, and may control another component in the electronic device 90 to perform a desired function.

The memory 92 may include one or more computer program products. The computer program product may include various forms of computer readable storage media, such as a volatile memory and/or a non-volatile memory. The volatile memory may include, for example, a random access memory (RAM) and/or a cache. The nonvolatile memory may include, for example, a read-only memory (ROM), a hard disk, and a flash memory. One or more computer program instructions may be stored on the computer readable storage medium. The processor 91 may execute the program instruction to implement the feature extraction method for a three-dimensional feature map according to various embodiments of the present disclosure that are described above and/or other desired functions. Various contents such as an input signal, a signal component, and a noise component may also be stored in the computer readable storage medium.

In an example, the electronic device 90 may further include an input device 93 and an output device 94. These components are connected to each other through a bus system and/or another form of connection mechanism (not shown).

For example, when the electronic device is the first device 100 or the second device 200, the input device 93 may be a microphone or a microphone array, which is configured to capture an input signal of a sound source. When the electronic device is a stand-alone device, the input device 93 may be a communication network connector for receiving the collected input signal from the first device 100 and the second device 200.

In addition, the input device 93 may further include, for example, a keyboard and a mouse.

The output device 94 may output various information to the outside, including determined distance information, direction information, and the like. The output device 94 may include, for example, a display, a loudspeaker, a printer, a communication network, and a remote output device connected to the communication network.

Certainly, for simplicity, FIG. 9 shows only some of components in the electronic device 90 that are related to the present disclosure, and components such as a bus and an input/output interface are omitted. In addition, according to specific application situations, the electronic device 90 may further include any other appropriate components.

### Exemplary Computer Program Product and Computer Readable Storage Medium

In addition to the foregoing method and devices, the embodiments of the present disclosure may also relate to a computer program product, which includes computer program instructions. When the computer program instructions are run by a processor, the processor is enabled to perform the steps, of the feature extraction method for a three-dimensional feature map according to the embodiments of the present disclosure, that are described in the “exemplary method” part of this specification.

The computer program product may be program code, written with one or any combination of a plurality of programming languages, that is configured to perform the operations in the embodiments of the present disclosure. The programming languages include an object-oriented programming language such as Java or C++, and further include a conventional procedural programming language such as a “C” language or a similar programming language. The program code may be entirely or partially executed on a user computing device, executed as a separate software package, partially executed on the user computing device and partially executed on a remote computing device, or entirely executed on the remote computing device or a server.

In addition, the embodiments of the present disclosure may further relate to a computer readable storage medium, which stores a computer program instruction. When the computer program instruction is run by the processor, the processor is enabled to perform the steps, of the feature extraction method for a three-dimensional feature map according to the embodiments of the present disclosure, that are described in the “exemplary method” part of this specification.

The computer readable storage medium may be one readable medium or any combination of a plurality of readable media. The readable medium may be a readable signal medium or a readable storage medium. The readable storage medium may include, for example, but is not limited to electricity, magnetism, light, electromagnetism, infrared ray, or a semiconductor system, an apparatus, or a device, or any combination of the above. More specific examples (a non-exhaustive list) of the readable storage medium include: an electrical connection with one or more conducting wires, a portable disk, a hard disk, a random access memory (RAM), a read-only memory (ROM), an erasable programmable read-only memory (EPROM or a flash memory), an optical fiber, a portable compact disk read-only memory (CD-ROM), an optical storage device, a magnetic storage device, or any suitable combination of the above.

Basic principles of the present disclosure are described above in combination with specific embodiments. However, it should be pointed out that the advantages, superiorities, and effects mentioned in the present disclosure are merely examples but are not for limitation, and it cannot be considered that these advantages, superiorities, and effects are necessary for each embodiment of the present disclosure. In addition, specific details described above are merely for examples and for ease of understanding, rather than limitations. The details described above do not limit that the present disclosure must be implemented by using the foregoing specific details.

The block diagrams of the equipment, the apparatus, the device, and the system involved in the present disclosure are merely exemplary examples and are not intended to require or imply that the equipment, the apparatus, the device, and the system must be connected, arranged, and configured in the manners shown in the block diagrams. It is recognized by a person skilled in the art that, the equipment, the apparatus, the device, and the system may be connected, arranged, and configured in an arbitrary manner. The terms such as “include”, “contain”, and “have” are open terms that mean “including but not limited to”, and may be used interchangeably with “including but not limited to”. It should be further pointed out that, various components or various steps in the apparatus, the device, and the method of the present disclosure may be disassembled and/or recombined. These disassembling and/or recombinations shall be regarded as equivalent solutions of the present disclosure.

What is claimed is:

1. A feature extraction method for a three-dimensional feature map, including:
determining an overlay parameter based on depth information of a three-dimensional feature map to be processed;
decomposing the three-dimensional feature map into a plurality of target two-dimensional feature maps based on the depth information and the overlay parameter;
performing two-dimensional convolution processing on each of the plurality of target two-dimensional feature maps to obtain a plurality of initial feature maps; and
determining a target feature map corresponding to the three-dimensional feature map based on the plurality of initial feature maps.

2. The method according to claim 1, wherein the determining an overlay parameter based on depth information of a three-dimensional feature map to be processed includes:
determining a weight value in a corresponding three-dimensional convolution kernel for the three-dimensional convolution processing on the three-dimensional feature map; and
determining the overlay parameter based on a first weight value in the three-dimensional convolution kernel corresponding to the depth dimension.

3. The method according to claim 1 wherein the decomposing the three-dimensional feature map into a plurality of target two-dimensional feature maps based on the depth information and the overlay parameter includes:
decomposing the three-dimensional feature map in a depth direction, so that the three-dimensional feature map is decomposed into a first number of two-dimensional feature maps, wherein the first number is an integer greater than 1; and
expanding a channel dimension in each of the first number of two-dimensional feature maps based on the overlay parameter to obtain the first number of target two-dimensional feature maps.

4. The method according to claim 3, wherein the expanding a channel dimension in each of the first number of two-dimensional feature maps based on the overlay parameter to obtain the first number of target two-dimensional feature includes:
performing a movement by a set stride in a direction of the depth information of the three-dimensional feature map based on the overlay parameter; and
determining the first number of target two-dimensional feature maps based on a first number of two-dimensional map groups obtained through a first number of times of movements.

5. The method according to claim 4, wherein the determining the first number of target two-dimensional feature maps based on a first number of two-dimensional map groups obtained through a first number of times of movements includes:
obtaining, based on each of the first number of times of movements, a two-dimensional feature map group including a second number of two-dimensional feature maps, the second number indicating a number of the overlay parameters; and
determining each of the two-dimensional feature map groups as a feature map on one channel in the target two-dimensional feature map, to obtain the first number of target two-dimensional feature maps with the second number of channels.

6. The method according to claim 1, wherein the performing two-dimensional convolution processing on each of the plurality of target two-dimensional feature maps to obtain a plurality of initial feature maps includes:
determining a corresponding two-dimensional convolution kernel for the two-dimensional convolution processing based on a corresponding three-dimensional convolution kernel for the three-dimensional convolution processing on the three-dimensional feature map; and
performing, based on the two-dimensional convolution kernel, two-dimensional convolution processing on each of the plurality of target two-dimensional feature maps to obtain the plurality of initial feature maps.

7. The method according to claim 6, wherein the determining a corresponding two-dimensional convolution kernel for the two-dimensional convolution processing based on a corresponding three-dimensional convolution kernel for the three-dimensional convolution processing on the three-dimensional feature map includes:
merging a first value of the corresponding depth dimension in the three-dimensional convolution kernel and a second value of a corresponding channel dimension in the three-dimensional convolution kernel, to obtain a third value; and
determining the third value as a value of a corresponding channel dimension in the two-dimensional convolution kernel to obtain the two-dimensional convolution kernel with a reduced number of dimensions.

8. The method according to claim 1, wherein the determining a target feature map corresponding to the three-dimensional feature map based on the plurality of initial feature maps includes:
overlaying the plurality of initial feature maps in the depth direction; and
obtaining the target feature map whose depth information corresponds to a value equal to the number of the initial feature maps.

9. A computer readable storage medium, in which a computer program is stored, wherein the computer program is used for implementing the feature extraction method for a three-dimensional feature map according to claim 1.

10. The computer readable storage medium according to claim 9, wherein the determining an overlay parameter based on depth information of a three-dimensional feature map to be processed includes:
determining a weight value in a corresponding three-dimensional convolution kernel for the three-dimensional convolution processing on the three-dimensional feature map; and
determining the overlay parameter based on a first weight value in the three-dimensional convolution kernel corresponding to the depth dimension.

11. The computer readable storage medium according to claim 9 wherein the decomposing the three-dimensional feature map into a plurality of target two-dimensional feature maps based on the depth information and the overlay parameter includes:
decomposing the three-dimensional feature map in a depth direction, so that the three-dimensional feature map is decomposed into a first number of two-dimensional feature maps, wherein the first number is an integer greater than 1; and
expanding a channel dimension in each of the first number of two-dimensional feature maps based on the overlay parameter to obtain the first number of target two-dimensional feature maps.

12. The computer readable storage medium according to claim 11, wherein the expanding a channel dimension in each of the first number of two-dimensional feature maps based on the overlay parameter to obtain the first number of target two-dimensional feature includes:
performing a movement by a set stride in a direction of the depth information of the three-dimensional feature map based on the overlay parameter; and
determining the first number of target two-dimensional feature maps based on a first number of two-dimensional map groups obtained through a first number of times of movements.

13. The computer readable storage medium according to claim 9, wherein the performing two-dimensional convolution processing on each of the plurality of target two-dimensional feature maps to obtain a plurality of initial feature maps includes:
determining a corresponding two-dimensional convolution kernel for the two-dimensional convolution processing based on a corresponding three-dimensional convolution kernel for the three-dimensional convolution processing on the three-dimensional feature map; and
performing, based on the two-dimensional convolution kernel, two-dimensional convolution processing on each of the plurality of target two-dimensional feature maps to obtain the plurality of initial feature maps.

14. The computer readable storage medium according to claim 9, wherein the determining a target feature map corresponding to the three-dimensional feature map based on the plurality of initial feature maps includes:
overlaying the plurality of initial feature maps in the depth direction; and
obtaining the target feature map whose depth information corresponds to a value equal to the number of the initial feature maps.

15. An electronic device, including:
a processor; and
a memory, configured to store a processor-executable instruction,
wherein the processor is configured to read the executable instruction from the memory, and execute the instruction to implement the feature extraction method for a three-dimensional feature map according to claim 1.

16. The electronic device according to claim 15, wherein the determining an overlay parameter based on depth information of a three-dimensional feature map to be processed includes:
determining a weight value in a corresponding three-dimensional convolution kernel for the three-dimensional convolution processing on the three-dimensional feature map; and
determining the overlay parameter based on a first weight value in the three-dimensional convolution kernel corresponding to the depth dimension.

17. The electronic device according to claim 15 wherein the decomposing the three-dimensional feature map into a plurality of target two-dimensional feature maps based on the depth information and the overlay parameter includes:
decomposing the three-dimensional feature map in a depth direction, so that the three-dimensional feature map is decomposed into a first number of two-dimensional feature maps, wherein the first number is an integer greater than 1; and
expanding a channel dimension in each of the first number of two-dimensional feature maps based on the overlay parameter to obtain the first number of target two-dimensional feature maps.

18. The electronic device according to claim 17, wherein the expanding a channel dimension in each of the first number of two-dimensional feature maps based on the overlay parameter to obtain the first number of target two-dimensional feature includes:
performing a movement by a set stride in a direction of the depth information of the three-dimensional feature map based on the overlay parameter; and
determining the first number of target two-dimensional feature maps based on a first number of two-dimensional map groups obtained through a first number of times of movements.

19. The electronic device according to claim 15, wherein the performing two-dimensional convolution processing on each of the plurality of target two-dimensional feature maps to obtain a plurality of initial feature maps includes:
determining a corresponding two-dimensional convolution kernel for the two-dimensional convolution processing based on a corresponding three-dimensional convolution kernel for the three-dimensional convolution processing on the three-dimensional feature map; and
performing, based on the two-dimensional convolution kernel, two-dimensional convolution processing on each of the plurality of target two-dimensional feature maps to obtain the plurality of initial feature maps.

20. The electronic device according to claim 15, wherein the determining a target feature map corresponding to the three-dimensional feature map based on the plurality of initial feature maps includes:
overlaying the plurality of initial feature maps in the depth direction; and
obtaining the target feature map whose depth information corresponds to a value equal to the number of the initial feature maps.
